(19) United States
(12) Patent Application Publication
(10) Pub. No.: US 2005/0144274 A1
(43) Pub. Date: Jun. 30, 2005

(54) Apparatus for monitoring the performance of a distributed system

(75) Inventors: Brock Estel Osborn, Niskayuna, NY (US); Harold Woodruff Tomlinson JR., Scotia, NY (US); John Erik Hershey, Ballston Lake, NY (US); Radislav Alexandrovich Potyrailo, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/735,505

(22) Filed: Dec. 12, 2003

(51) Int. Cl. G06F 15/173

(52) U.S. Cl. 709/224

(57) ABSTRACT

An apparatus for monitoring the performance of a distributed system is provided. The distributed system comprises a plurality of cooperating units disposed in a communications network. The apparatus comprises a plurality of diagnostic components wherein each unit of the system comprises at least one of the diagnostic components. Each diagnostic component comprises a sensor, a data reduction module, a transceiver and a data analysis module. The sensors sense unit performance characteristics and represent the characteristics as raw data. The data reduction module receives and processes the raw data produced by the sensors to generate reduced data. The transceiver receives the reduced data from the data reduction module and transmits and receives the reduced data to and from the units using the network. The data analysis module accepts and analyzes the reduced data from the transceiver to produce performance data related to the distributed system.

### BACKGROUND

The invention generally relates to monitoring the performance of a distributed system and more specifically to an apparatus for efficient processing of performance data related to a distributed system.

Performance monitoring and life estimation in large and distributed systems typically comprises collecting data from a number of separate but geographically close units within the system and transporting the collected data to a central location where it is processed. The central location comprises a processor that senses, processes, and monitors the data from the various units comprising the system. The central location is usually connected to the units via a shared or dedicated communication network. Some examples of large and distributed systems include locomotives, aircraft engines, automobiles, turbines, computers and appliances.

The use of a single central location for data processing and communication increases the latency and congestion in the communication network due to heavy data traffic between the units comprising the distributed system and the central location. This incurs a large communication overhead, data organization/retrieval complexity and data storage overhead between the units and the central location. A central location is also a single point of failure and is not a scalable solution as more units are added to the distributed system.

In some conventional distributed systems, data processing in each individual system unit is performed locally, based on a command by a central location in the distributed system. The units then send the processed data to the central location. The central location may then utilize the processed data from the units to determine an estimate of the remaining lifetime of the distributed system, or perform calculations related to the performance of the distributed system. The units comprising such a distributed system do not cooperate with one another to estimate the remaining lifetime of the distributed system and still require the presence of a central location to perform the computations. This technique somewhat reduces, but does not eliminate, the amount of data processing required of a central location.

A desirable apparatus would thus allow for more efficient processing and flow of performance data among a plurality of cooperating units in a distributed system.

### BRIEF DESCRIPTION

Embodiments of the present invention address this and other needs. In one embodiment, an apparatus for monitoring the performance of a distributed system is provided. The distributed system comprises a plurality of cooperating units disposed in a communications network. The apparatus comprises a plurality of diagnostic components wherein each unit of the system comprises at least one of the diagnostic components. Each diagnostic component comprises at least one sensor, a data reduction module, a transceiver and a data analysis module. The sensors sense unit performance characteristics and represent the characteristics as raw data. The data reduction module receives and processes the raw data produced by the sensors to generate reduced data. The transceiver receives the reduced data from the data reduction module and transmits and receives the reduced data to and from the units using the network. The data analysis module accepts and analyzes the reduced data from the transceiver to produce performance data related to the distributed system.

In another embodiment, a method for monitoring the performance of a distributed system is provided. The distributed system comprises a plurality of cooperating units disposed in a communications network. The method comprises sensing unit performance characteristics and representing the characteristics as raw data. The method further comprises processing the raw data to generate reduced data. The reduced data is then transmitted to and from the units using the network. The reduced data is further analyzed to produce performance data related to the distributed system.

### DRAWINGS

These and other features, aspects, and advantages of the invention will become better understood when the following detailed description is read with reference to the accompanying drawings in which like characters represent like parts throughout the drawings, wherein:

FIG. 1 is an illustration of a traditional communications network for monitoring the performance of a distributed system;

FIG. 2 is an illustration of a distributed system according to one embodiment of the present invention;

FIG. 3 is an illustration of the components of a unit comprising the distributed system of FIG. 2 according to one embodiment of the present invention; and

FIG. 4 is a flowchart describing the steps performed to monitor the performance of a distributed system.

### DETAILED DESCRIPTION

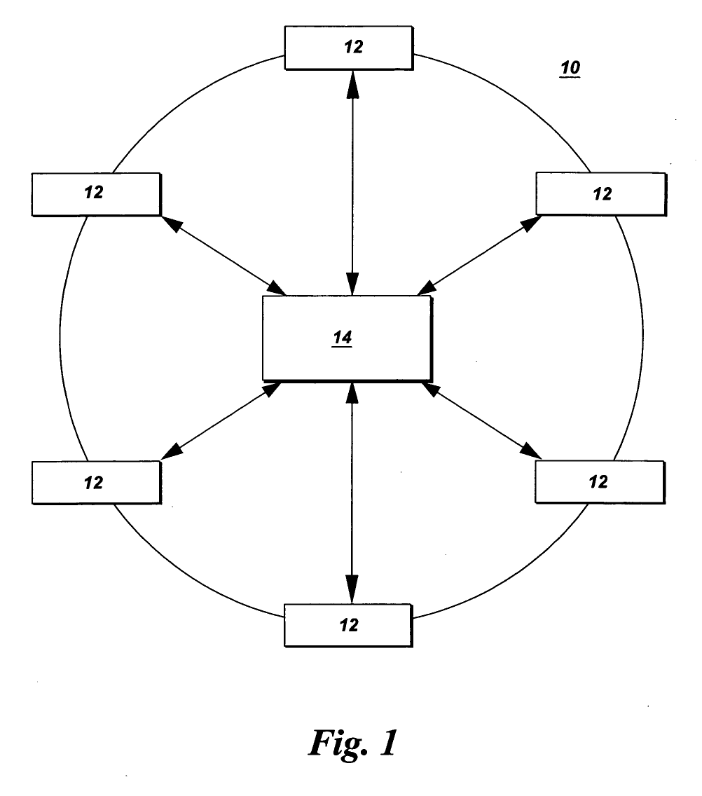

FIG. 1 is an illustration of a traditional communications network for monitoring the performance of a distributed system. The distributed system 10 comprises a plurality of units 12. As depicted in FIG. 1, each of the units 12 communicates its data to a central location 14. The central location 14 comprises a processor that receives and processes the data from the plurality of units 12 to produce performance data related to the distributed system 10. As described above, the challenge with using such a central location for data communication involves a large communication overhead, data organization/retrieval complexity, data storage overhead and data synchronization between the units in the system and the central location.

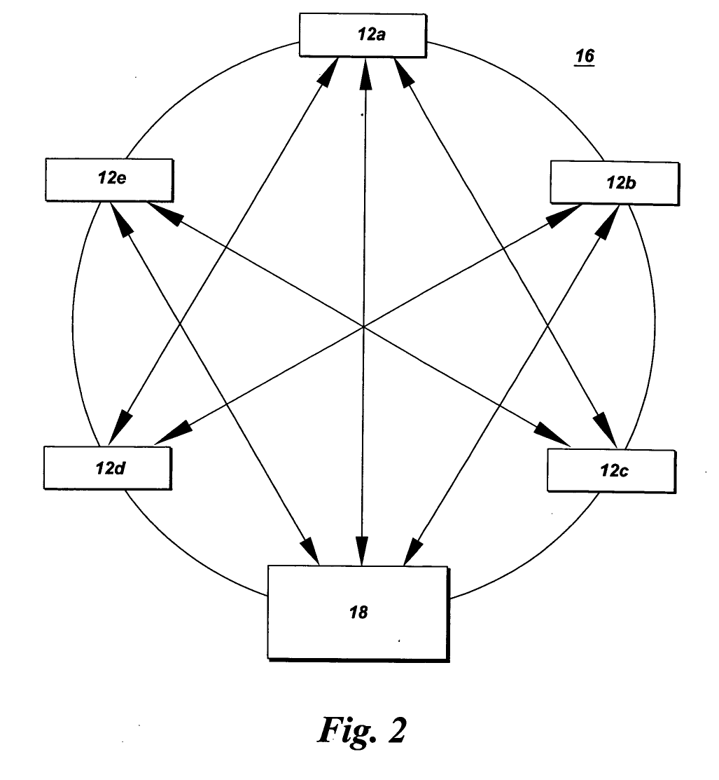

FIG. 2 is an illustration of a distributed system 16 according to one embodiment of the present invention. Those skilled in the art will appreciate that in monitoring the performance of a distributed system 16, the apparatus of the present invention is applicable to many and various applications; as used herein the term “performance” encompasses the physical condition, operational efficiency, projected remaining operational lifetime, and security of units 12 in the system, as non-limiting examples.

As depicted in FIG. 2, the distributed system 16 comprises a plurality of cooperating units 12 (labeled 12a-12e) disposed in a communications network. As used herein, the term “communications network” refers to a network wherein each unit 12 is capable of communication with all other units 12 comprising the system 16. The communications network may be configured in one or more of a variety of network configurations, which include, for example, wireless and wired network configurations. The wired network may be connected by a communications medium selected from the group consisting of metallic wire cables, fiber optic cables and Ethernets. The cables comprise any of several suitable forms known to those in the art, including, for example, dedicated communication lines or shared power lines joining the units. The wireless network may be selected from the group consisting of radio waves, wireless LAN's, satellite networks and mobile telecommunications systems. Further, the network comprising system 16 may also be configured to be accessible via the Internet.

In a specific embodiment, the communications network of the system 16 is configured as a wireless network. It is further envisioned that, in certain situations, all units 12 comprising the system 16 would not be necessarily within communication range of one another at all times. In such a case, when a unit 12 wishes to participate in information exchange with the other units 12 comprising the system 16, it comes within communication range of a unit 12 in the network and a wireless network connection is established to facilitate the information exchange. For this embodiment, then, at any given point in time, only a subset of units comprising the system 16 actively participates in information exchange. As will be appreciated by those skilled in the art, this non-continuous communication arrangement results in reduced communication overhead among the units 12 comprising the system 16 and efficient utilization of the communication capacity of the system 16. This subset of units is referred to as an active subset of units because these units are actively in cooperation and communication with each other at any given point in time.

Operationally, in accordance with a particular embodiment of the invention, a unit 12 comprising the system 16 that wants to participate in information exchange with one or more other units 12 first contacts a publish/subscribe server (PSS) 18 as illustrated in FIG. 2. The PSS 18 functions as an electronic bulletin board and displays a list of the active subset of units and the type of information that they want to provide or acquire. In a specific embodiment, at least one unit 12 of the plurality of units 12 further comprises a PSS 18. Each unit 12 comprising the system 16 periodically queries the PSS 18 to determine if it is a potential user of information currently advertised on the PSS 18. The units 12 that want to receive this information then establish a direct communication link with the unit 12 that wants to exchange the information. Multiple units 12 comprising the system 16 may be configured as PSS's to act as backup units in the event that the initially configured PSS 18 is inoperable or out of communication range. As is apparent from the above discussion, the PSS 18 manages the data flow on the network. In addition, the PSS 18 facilitates efficient distribution of processed data among the units 12 comprising the system 16 and also increases the reliability of the system 16.

As is apparent from the above discussion, the system 16 of the invention advantageously eliminates the need for a central location for processing data from the units. Each unit 12 comprising the system 16 establishes direct communication paths with the other units 12 when it wants to exchange information. Each unit 12 then processes the information it receives from the other units 12 locally to produce performance data related to the system 16.

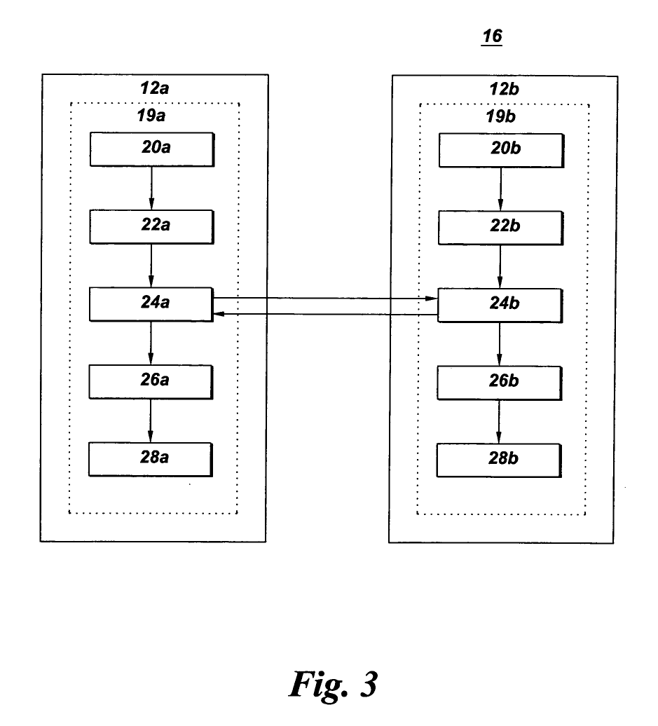

FIG. 3 is an illustration of the apparatus for monitoring the performance of the distributed system 16 of FIG. 2 according to one embodiment of the present invention. As shown in FIG. 3, the apparatus comprises a diagnostic component 19, wherein each unit 12 of the distributed system 16 comprises the diagnostic component 19. FIG. 3 also depicts a typical interaction between two units, 12a and 12b comprising the system 16.

As shown in FIG. 3, each diagnostic component 19 further comprises at least one sensor 20, a data reduction module 22, a transceiver 24, a data analysis module 26a and a user interface module 28a. The sensor(s) 20a sense unit performance characteristic(s) and represent the characteristic(s) as raw data. In operation, the sensor(s) 20a continuously measure changes to the value of performance characteristic(s) related to the operation of the unit and represent the performance characteristic(s) as raw data. Any of various sensors known in the art are suitable for use in embodiments of the present invention, including, for example, chemical sensors for detecting the presence of certain chemical species; biological sensors for detecting and quantifying biological organisms, electrochemical sensors for determining electrochemical potential and detecting chemical and electrochemical species; mechanical sensors, such as, for example, vibration sensors, motion sensors, and stress sensors; thermal sensors for detecting temperatures and changes thereof; environmental sensors for determining such exemplary parameters as humidity, temperature, and pH; and financial performance sensors for detecting levels of such exemplary parameters as sales, revenues, and profits.

The data reduction module 22 is adapted to receive and process the raw data produced by the sensors to generate reduced data using at least one statistical technique. A number of statistical techniques are known in the art, for example, comparison of the raw data to a predetermined specification value, statistical correlation, trend analysis, regression, and multivariate statistical techniques.

As will be appreciated by those skilled in the art, sensor measurements may be taken from a single sensor, or from an array of sensors. Therefore, sensor responses may be monitored from a single sensor or from more than one sensor. Multiple types of responses from a single sensor can be transformed to reduced data using multivariate statistical techniques, several of which are well known in the art. For example, Potyrailo, R. A.; May, R. J., Rev. Sci. Instrum. 2002, 1277-1283, describes the use of multivariate statistical techniques for processing sensor data by generating multiple responses from dynamic sensor measurements upon exposure to an analyzed sample. Response characteristics of sensors are also analyzed using well-known statistical techniques such as, for example, calibrations. Such techniques are suitable for use in embodiments of the present invention by the data reduction module 22 to reduce data received from sensors 20.

The transceiver 24 is adapted to receive the reduced data from the data reduction module 22 and to transmit and receive the reduced data to and from the plurality of units 12 using the network. The data analysis module 26 is adapted to accept and analyze the reduced data from the transceiver 24 to produce performance data related to the system 16. Performance data is data that provides direct insight into the state of system operations, allowing the user to draw conclusions and take appropriate actions to maintain performance at acceptable levels and to correct nonconforming conditions. Examples of performance data include, but are not limited to, effective power output of a power generation system, exhaust gas temperature measurements from a jet engine, gas byproduct measurements from transformer units etc. In certain specific embodiments of the invention, the data analysis module utilizes the performance data to estimate the remaining lifetime of the distributed system 16.

In particular embodiments, the data analysis module 26 is further adapted to process and interpret the reduced data by at least one statistical technique. A number of statistical analysis techniques for drawing actionable conclusions from data are known in the art, such as, for example, correlation techniques, multivariate statistical process analysis, and pattern recognition techniques.

Several pattern recognition techniques are known in the art and are suitable for use by the data analysis module for data analysis. These techniques include, but are not limited to, Bayesian decision theory, neural networks, fuzzy logic, Parzen windows, nearest neighbor classification, hidden Markov models, linear and non-linear discriminant analysis, Markov random fields, Boltzmann learning, classification and regression trees, and multivariate adaptive regression. As will be appreciated by those skilled in the art, pattern recognition techniques comprise chemometric analysis techniques such as principal component analysis (PCA) to assess potential outliers in the analysis of one, or multiple, environmental sensor variables. An application of PCA for analysis of sensor array data is described in Potyrailo, R. A.; May, R. J.; Sivavec, T. M., Proc. SPE 3856, 80-87 (1999). Multivariate statistical process analysis (MSPA) methods are used to extract information from measured sensor data. MSPA methods have been utilized, for example, in materials production processes to improve the productivity of manufacturing plants, to monitor the processing conditions and to control the performance of sensors. US Patent Application Number U.S. Pat. No. 6,549,864 provides a more detailed discussion of MSPA methods with sensor analysis.

A user interface module 28, in some embodiments, is adapted to receive the system performance data from the data analysis module 26 and communicate the system performance data of the distributed system 16 to a user. A user interface module includes, for example, an output device such as a printer or video monitor to allow the user access to the performance data, as well as an input device such as a communications port to allow the network access to the user interface module.

It will be appreciated that the decentralization of the sensors 20 and sensor processing in the diagnostic components 19 of the units 12 enable individual units within the distributed system 16 to benefit from the experience of all units within the system. As an example of such a benefit, individual units experiencing unusual environmental or other operating conditions can collect data on the conditions and their effects on unit performance and make this information available to the other units in the system. Should such conditions arise elsewhere within the system, the affected units will be able to access this new information and individually customize their analyses to account for the estimated effects of the conditions, thereby providing more accurate performance data. For example, there is an on-going need to understand how a jet engine performs under various adverse environmental conditions such as in presence of dust, hail, etc. If on a particular day, a weather report indicated that dust storms were present at various locations, data would be collected from specific sensors on those aircrafts flying through these locations to take time series measurements of dust concentration, turbine fan speed, exhaust gas temperature, etc. and determine how these variables change with respect on another. Furthermore, when these engines enter the service shop for repair, the wear on specific engine parts will be related to these measurements. Using the results of these analyses, the scheduling of future preventative maintenance activities can be related to dust concentration measurements in order to maximize overall engine life and optimize engine performance.

In accordance with a specific embodiment of the invention, the units 12 of the distributed system 16 are a plurality of transformers. Large transformers represent a significant fixed plant cost and investment. The lifetime of a transformer is typically influenced by many factors including operating and environmental conditions. The lifetime of a transformer is significantly shortened by overloading the transformer or operating the transformer under adverse conditions. As will be appreciated by one skilled in the art, transformers experience an elevated winding core temperature during high load conditions, such as during periods of high demand for electricity, for example during a hot summer month. As a result, the transformer dielectric degrades at a much faster than normal rate and this degradation is usually reflected in an increased concentration of transformer fluid. As a consequence, the physical lifetime of the transformer may expire even before its residual value has been completely depreciated. Therefore, monitoring transformers results in a significant value to power system operators in arbitrating peak demands, load shedding and diversion.

In embodiments of the present invention, each transformer comprises a diagnostic component 19 comprising at least one sensor 20, a data reduction module 22, a transceiver 24, a data analysis module 26 and a user interface module 28. In a specific embodiment, the diagnostic component 19 is configured to estimate the remaining lifetime of the distributed system 16 by measuring correlations between a plurality of environmental conditions and excessive loading in the transformer units. The sensors 20 sense a performance characteristic related to the transformer and represent the characteristics as raw data. In an example of this embodiment, the sensors 20 are configured to measure a gas byproduct produced by degradation of transformer winding insulation, particularly at transformer hot spots. In a more specific embodiment, the gas byproduct measured by the sensors 20 and used to estimate the degradation of the transformer's insulation comprises acetylene or ethylene. In a still more specific embodiment, the sensors 20 measure the variability in the concentrations in the levels of ethylene in the transformer units, and transform the measurements into raw data. The data reduction module 22 determines second derivatives of the ethylene volume based on the raw data. The second derivative of volume is equivalent to the first derivative of the rate of the ethylene levels. The data reduction module 22 locally compares the second derivatives of the volume, at each transformer unit, to a pre-defined threshold value. The data reduction modules 22 in the transformer then report via the transceiver 24 the increased accumulation rate of ethylene (determined by an increase in the pre-defined threshold value) to other transformers in the system 16. The data analysis module 26 in each transformer unit processes and interprets the data reported by its data reduction module 22 and the data reduction modules 22 from the nearby transformer units. By comparing the accumulation rates of ethylene in each of the transformers in the network, analyses can be made to determine if transformers are degrading at the same rate over time, or if the location of the transformer in the network is an important factor. Using these analyses, predictions may be made of how accumulation rates of ethylene in other transformers in the network will increase over time, leading to proactive maintenance strategies for the transformers. Accumulation rate of ethylene can also be correlated with actual failure times of the transformers (using, for example, well known lifetime regression models) to better predict when transformers will fail in order to better schedule maintenance.

As described above, the apparatus of the present invention, in certain embodiments, monitors the security of units 12 (FIG. 2) in distributed system 16. Those skilled in the art will appreciate that security of certain types of units 12 is an important concern. Such units include, but are not limited to, residences, military installations, and vehicles, including airplanes, trains, and ships and airport facilities for example.

By disposing such units in a communications network in accordance with embodiments of the present invention as described above, the units become part of a distributed system 16 and the apparatus of the invention is used to monitor the security of the units 12. In such embodiments, the performance characteristics monitored by sensors 20 (FIG. 3) include characteristics related to the security of the unit, which vary depending on the identity of a unit and are readily apparent to those skilled in the art. For example, performance characteristics related to the security of passenger airliners include, but are not limited to, altitude and rate of altitude change, position and deviation from flight plan, velocity and rate of velocity change, and the like.

In some embodiments, monitoring the security of units is as simple as monitoring for a particular event, such as the unauthorized opening of a door to a restricted area. In other embodiments, the apparatus is used to monitor for and discern a threat based on an analysis of several variables, and to communicate a threat alert to the other units, and, where applicable, to a user interface module 28. In certain embodiments, pattern recognition techniques are used by the data analysis module 26 to discern whether or not the combination of measured performance characteristics and their behavior over time indicate an alert condition, such as a hijacking or a potential security threat.

Having the units disposed in a network in accordance with embodiments of the present invention advantageously allows for more reliable threat recognition than that allowed by analysis of data from units lacking the ability to cooperate. For example, data shared on the network is used in the analysis to account for variations in behavior due to external factors that would, for example, tend to create false positive threat signals.

In certain embodiments, the apparatus of the present invention is used to monitor the security status of an entire area, such as, for example, in an airport or a military installation. In this embodiment, each cooperating unit 12 comprising the apparatus is a separately deployed security system, and the security status of the entire area is monitored by linking together the units. The sensors comprising such a unit monitor one or more performance characteristics related to the security mission of the unit. For example, performance characteristics related to security installations such as military bases and airports include, but are not limited to, open door sensor status signals, fire sensor signals, water pressure sensor signals, structural displacement signals, personnel inspection alert signals, motion detector signals, baggage inspection alert signals, and security personnel alert signals. The data analysis module processes and interprets the data from the sensors to determine the security status of the entire area. The security status of the cooperating units (security systems) is further displayed to an authorized individual or to an artificial intelligence processor. This enables the individual or the processor to obtain a broader view of security, than can be obtained by monitoring only a single security system.

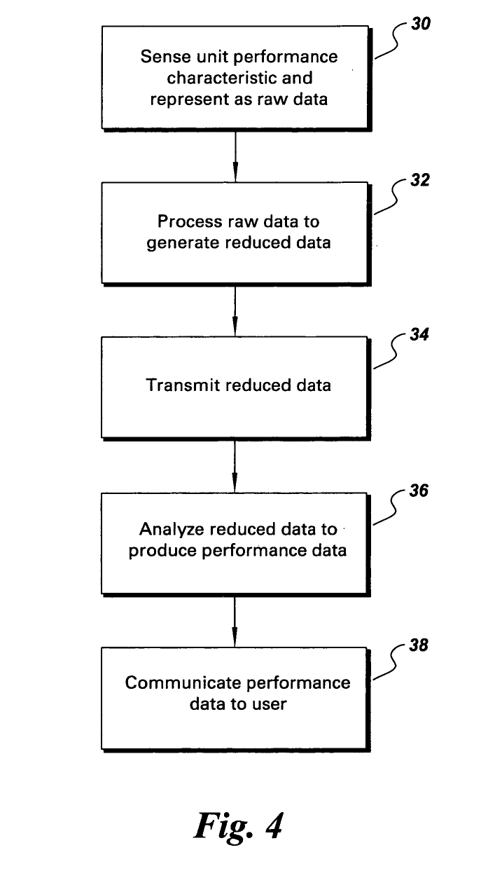

Another aspect of the invention as shown in FIG. 4, is a method for monitoring the performance of a distributed system 16 comprising a plurality of cooperating units 12 disposed in a communications network. FIG. 4 is a flowchart describing the steps performed to monitor the performance of a distributed system 16. In a specific embodiment, the plurality of units 12 comprises a plurality of transformers. The method comprises sensing at least one unit performance characteristic and representing said at least one characteristic as raw data in step 30. In a specific embodiment, the sensing comprises measuring a gas byproduct produced by degradation of transformer winding insulation. In step 32 the raw data is processed to generate reduced data. As described above, processing the raw data comprises using at least one statistical technique selected from the group consisting of comparison of said raw data to a predetermined specification value, statistical correlation, trend analysis, regression, calibrations and multivariate analysis techniques. In step 34, the reduced data is transmitted to and from the plurality of units using the network. In a specific embodiment, the network comprises a wireless network. In step 36, the reduced data is analyzed to produce performance data related to the distributed system 16. As described in FIG. 2, analyzing the reduced data comprises processing and interpreting the reduced data using at least one statistical technique selected from the group consisting of correlation techniques, multivariate statistical process analysis, and pattern recognition techniques. Then the performance data of the distributed system is communicated to a user in step 38. In certain specific embodiments of the invention, the performance data produced in step 36 is utilized to estimate a remaining lifetime of the distributed system 16.

The embodiments described above have several advantages, including the ability of the distributed system of the invention to perform meaningful correlations of sensor data to environmental and system loading. The ability of the distributed system of the invention to carry out statistical experiments locally within each unit eliminates the need for data transfer to a central location for analysis. As will be appreciated by one skilled in the art, the distributed system of the invention can comprise components of an engine, for example, locomotives, automobiles, turbines or internal combustion engines.

Accordingly, the above-identified shortcomings of the traditional communications network for monitoring the performance of a distributed system are overcome by embodiments of the invention, which relates to an apparatus for efficient processing of performance data related to a distributed system.

While the invention may be susceptible to various modifications and alternative forms, specific embodiments have been shown by way of example in the drawings and have been described in detail herein. However, it should be understood that the invention is not intended to be limited to the particular forms disclosed. The invention, therefore, is to cover all modifications, equivalents, and alternatives falling within the spirit and scope of the invention as defined by the following appended claims.

1. An apparatus for monitoring the performance of a distributed system, said distributed system comprising a plurality of cooperating units disposed in a communications network, wherein said apparatus comprises:
a plurality of diagnostic components, wherein each unit of said system comprises at least one of said diagnostic components, and wherein each diagnostic component further comprises
a. at least one sensor for sensing at least one unit performance characteristic and representing said at least one characteristic as raw data;
b. a data reduction module adapted to receive and process said raw data produced by said at least one sensor to generate reduced data;
c. a transceiver adapted to receive said reduced data from said data reduction module and to transmit and receive said reduced data to and from said plurality of units using said network; and
d. a data analysis module adapted to accept and analyze said reduced data from said transceiver to produce performance data related to said distributed system.

2. The apparatus of claim 1, wherein said data analysis module utilizes said performance data to estimate a remaining lifetime of said distributed system.

3. The apparatus of claim 1, wherein each said diagnostic component further comprises at least one user interface module adapted to receive said system performance data from said data analysis module for communicating said system performance data of said distributed system to a user.

4. The apparatus of claim 1, wherein at least one unit of said plurality of units further comprises a publish/subscribe server (PSS), and wherein said transceiver is adapted to communicate with said PSS to manage data flow on said network.

5. The apparatus of claim 1, wherein said plurality of units comprises a plurality of transformers.

6. The apparatus of claim 5, wherein the plurality of transformers comprises sensors configured to measure a gas byproduct produced by degradation of transformer winding insulation.

7. The apparatus of claim 1, wherein said plurality of units comprises a plurality of components of an engine.

8. The apparatus of claim 7, wherein said engine is selected from the group consisting of turbines and internal combustion engines.

9. The apparatus of claim 1, wherein said at least one performance characteristic is selected to measure the security of said units.

10. The apparatus of claim 9, wherein said units comprise passenger airliners, and wherein said at least one performance characteristic is at least one of altitude, rate of altitude change, position, deviation from flight plan, velocity, and rate of velocity change.

11. The apparatus of claim 1, wherein said network comprises a wireless network.

12. The apparatus of claim 11 wherein said wireless network is selected from the group consisting of radio waves, wireless LAN's, satellite networks and mobile telecommunications systems.

13. The apparatus of claim 11, wherein said wireless network is configured to support communication among at least one active subset of said plurality of units, wherein said active subset comprises a subset of said plurality of units comprising said distributed system that are actively in cooperation and communication with each other.

14. The apparatus of claim 1, wherein said network comprises a wired network.

15. The apparatus of claim 14, wherein said wired network is connected by a communications medium selected from the group consisting of metallic wire cables, fiber optic cables and Ethernets.

16. The apparatus of claim 1, wherein said network is configured to be accessible via the Internet.

17. The apparatus of claim 1, wherein said at least one sensor of said diagnostic component is selected from the group consisting of chemical sensors, biological sensors, electrochemical sensors, mechanical sensors, vibration sensors, stress sensors, thermal sensors, environmental sensors and financial performance sensors.

18. The apparatus of claim 1, wherein said data reduction module of said diagnostic component is adapted to process said raw data by at least one statistical technique selected from the group consisting of comparison of said raw data to a predetermined specification value, statistical correlation, trend analysis, regression, calibrations, and multivariate statistical techniques.

19. The apparatus of claim 1, wherein said data analysis module of said diagnostic component is adapted to process and interpret said reduced data by at least one statistical technique selected from the group consisting of correlation techniques, multivariate statistical process analysis, and pattern recognition techniques.

20. An apparatus for monitoring the performance of a distributed system, said distributed system comprising a plurality of cooperating units disposed in a communications network, wherein said apparatus comprises:
a plurality of diagnostic components, wherein each unit of said system comprises at least one of said diagnostic components, and wherein each diagnostic component further comprises
a. at least one sensor for sensing at least one unit performance characteristic and representing said at least one characteristic as raw data;
b. a data reduction module adapted to receive and process said raw data produced by said at least one sensor to generate reduced data, wherein said raw data is processed by at least one statistical technique selected from the group consisting of comparison of said raw data to a predetermined specification value, statistical correlation, trend analysis, regression, calibrations, and multivariate statistical techniques;
c. a transceiver adapted to receive said reduced data from said data reduction module and to transmit and receive said reduced data to and from said plurality of units using said network;
d. a data analysis module adapted to accept and analyze said reduced data from said transceiver to produce performance data related to said distributed system, wherein said reduced data is analyzed using at least one statistical technique selected from the group consisting of correlation techniques, multivariate statistical process analysis and pattern recognition techniques; and
e. at least one user interface module adapted to receive said system performance data from said data analysis module for communicating said system performance data of said distributed system to a user;

21. A method for monitoring the performance of a distributed system comprising a plurality of cooperating units disposed in a communications network, said method comprising:
sensing at least one unit performance characteristic and representing said at least one characteristic as raw data;
processing said raw data to generate reduced data;
transmitting said reduced data to and from said plurality of units using said network; and
analyzing said reduced data to produce performance data related to said distributed system;
wherein each unit comprises at least one diagnostic component configured to perform the steps comprising said method.

22. The method of claim 21 further comprising communicating said performance data of said distributed system to a user.

23. The method of claim 21, wherein said plurality of units comprises a plurality of transformers.

24. The method of claim 23 wherein sensing further comprises measuring a gas byproduct produced by degradation of transformer winding insulation.

25. The method of claim 21, wherein said network comprises a wireless network.

26. The method of claim 21, wherein processing said raw data comprises using at least one statistical technique selected from the group consisting of comparison of said raw data to a predetermined specification value, statistical correlation, trend analysis, regression, calibrations and multivariate statistical techniques.

27. The method of claim 21, wherein analyzing said reduced data comprises processing and interpreting said reduced data using at least one statistical technique selected from the group consisting of correlation techniques, multivariate statistical process analysis, and pattern recognition techniques.

28. An apparatus for monitoring the performance of a distributed system, said distributed system comprising a plurality of cooperating units disposed in a communications network, wherein said apparatus comprises:
a plurality of diagnostic components, wherein each unit of said system comprises at least one of said diagnostic components, and wherein each diagnostic component further comprises
a. at least one sensor for sensing at least one unit performance characteristic and representing said at least one characteristic as raw data, wherein said at least one performance characteristic is selected to measure the security of said units.
b. a data reduction module adapted to receive and process said raw data produced by said at least one sensor to generate reduced data;
c. a transceiver adapted to receive said reduced data from said data reduction module and to transmit and receive said reduced data to and from said plurality of units using said network; and
d. a data analysis module adapted to accept and analyze said reduced data from said transceiver to produce performance data related to said distributed system, wherein the data analysis module utilizes said performance data in a pattern recognition technique to discern a potential security threat related to said units.

29. The apparatus of claim 28, wherein said plurality of cooperating units comprise passenger airliners, and wherein said at least one performance characteristic is at least one of altitude, rate of altitude change, position, deviation from flight plan, velocity and rate of velocity change.

30. The apparatus of claim 28, wherein said distributed system comprises a plurality of security systems monitoring the security of an area, and wherein said performance characteristic is at least one of open door sensor status signals, fire sensor signals, water pressure sensor signals, structural displacement signals, personnel inspection alert signals, baggage inspection alert signals, and security personnel alert signals.
